(19) United States
(12) Patent Application Publication
(10) Pub. No.: US 2009/0038005 A1
(43) Pub. Date: Feb. 5, 2009

(54) PRIVILEGE-BASED ACCESS SYSTEM

(75) Inventor: Arthur G. Howarth, Orleans (CA)

Correspondence Address: Weaver Austin Villeneuve & Sampson LLP, P.O. BOX 70250, OAKLAND, CA, 94612-0250, US

(73) Assignee: Cisco Technology, Inc.

(21) Appl. No.: 11/831,705

(22) Filed: Jul. 31, 2007

(51) Int. Cl. G06F 21/20

(52) U.S. Cl. 726/21

(57) ABSTRACT

In one embodiment, an apparatus comprises a network interface system and a logic system. The network interface system comprises at least one network interface. The logic system comprises at least one logic device configured to do the following: receive, via the network interface system, task indications that a first person has completed predetermined tasks; ascertain points to award for the predetermined tasks; receive, via the network interface system, an access request to access identified content; determine a number of points required for granting the access request; determine a number of points currently available to the first person; determine whether to grant the access request; and send, via the network interface system, a message to a device indicating whether to grant the access request.

### BACKGROUND OF THE INVENTION

1. Field of the Invention

The present invention relates to methods for controlling access to devices.

2. Description of the Related Art

In many hierarchical contexts, one or more responsible people may want to influence the behavior of others. For example, parents want their children to accomplish tasks, whether homework, housework, exercise, perform community service, etc. Employers want their employees to perform their appointed tasks. The responsible parties may also want others to refrain from, or at least to limit, other activities. Both parents and employers, for example, may want to regulate time spent online, playing computer games, on the telephone, watching television, etc.

Existing systems and methods have proven to be only partially effective in accomplishing these goals. It would be desirable to address at least some shortcomings of the prior art.

### BRIEF DESCRIPTION OF THE DRAWINGS

FIG. 1 is a flow chart that outlines a process of enrolling a person in a privilege-based access system.

FIG. 2A is a flow chart that outlines a process of accruing points in a privilege-based access system.

FIG. 2B is a network diagram that illustrates various entities that may be involved in a process of accruing points in a privilege-based access system such as that outlined in FIG. 2A.

FIG. 2C is an example of a graphical user interface (“GUI”) that may be provided to assist the parent (or other responsible party) in providing authorization indications in a privilege-based access system such as that outlined in FIG. 2A.

FIG. 3A is a flow chart that outlines a process of controlling access to devices and/or content in a privilege-based access system.

FIG. 3B is a network diagram that illustrates various entities that may be involved in a process of controlling access to devices and/or content in a privilege-based access system such as that outlined in FIG. 3A.

FIG. 3C is a flow chart that outlines a process of controlling access to devices and/or content in a privilege-based access system after access has initially been granted, e.g., according to the process outlined in FIG. 3A.

FIG. 4 illustrates a process of evaluating and modifying a task verification frequency.

### DESCRIPTION OF EXAMPLE EMBODIMENTS

### Overview

In one embodiment, an apparatus comprises a network interface system and a logic system. The network interface system comprises at least one network interface. The logic system comprises at least one logic device configured to do the following: receive, via the network interface system, task indications that a first person has completed predetermined tasks; ascertain points to award for the predetermined tasks; receive, via the network interface system, an access request to access identified content; determine a number of points required for granting the access request; determine a number of points currently available to the first person; determine whether to grant the access request; and send, via the network interface system, a message to a device indicating whether to grant the access request.

### Example Embodiments

In this application, numerous specific details are set forth in order to provide a thorough understanding of the present invention. It will be obvious, however, to one skilled in the art, that the present invention may be practiced without some or all of these specific details. In other instances, well known process steps have not been described in detail in order not to obscure the present invention.

Various techniques and mechanisms of the present invention will sometimes be shown and/or described in singular form for clarity. However, it should be noted that some embodiments may include multiple iterations of a technique or multiple instantiations of a mechanism unless noted otherwise. For example, a system may use a processor to perform certain tasks. However, it will be appreciated that such a system could use multiple processors to perform the same tasks.

Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection that is illustrated and/or described does not necessarily mean a direct, unimpeded connection unless otherwise noted.

Moreover, although much of the present discussion will be focused on privilege-based access systems involving parents and children, these are merely examples. There are various contexts in which one or more people (sometimes referred to herein as “responsible people” or the like) may want to use privilege-based access to devices and/or content in order to influence the behavior of others. For example, employers want their employees to do their jobs and avoid spending an excessive amount of time online, playing computer games, making personal calls on the telephone, text messaging, etc. In addition, the responsible people may want to discourage other types of behavior, such as rudeness, tardiness, absences, smoking, drinking, etc.

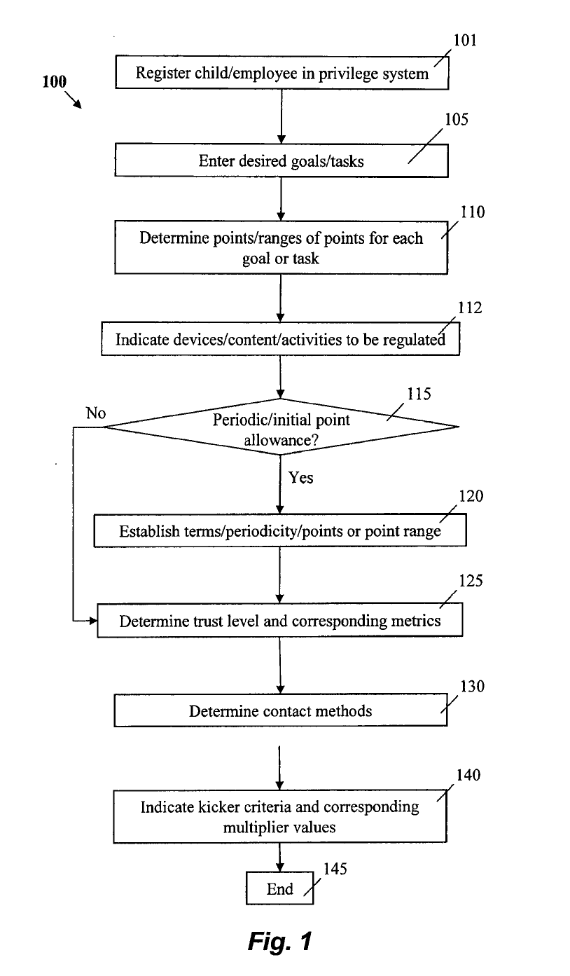

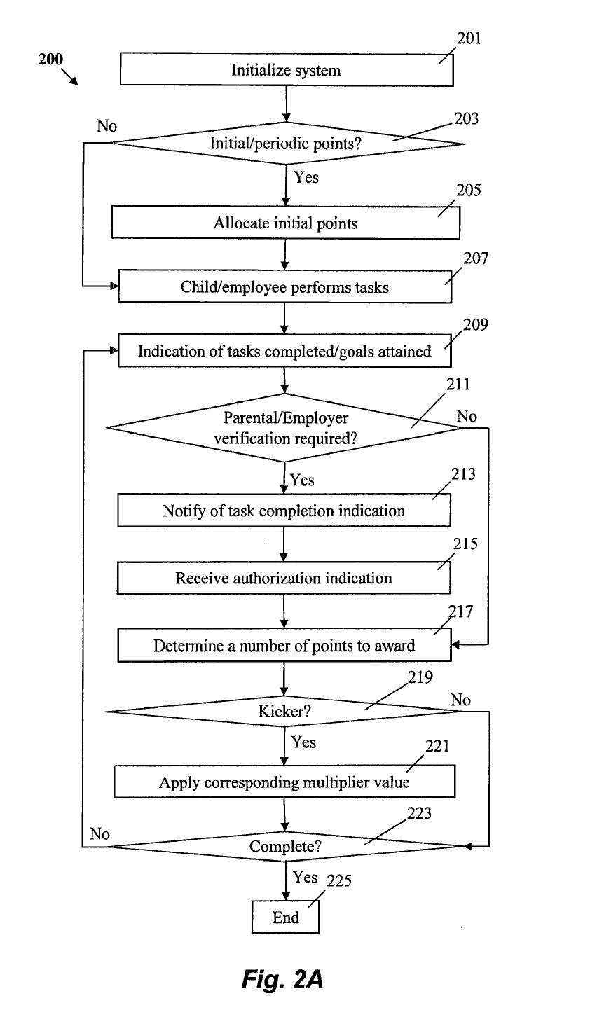

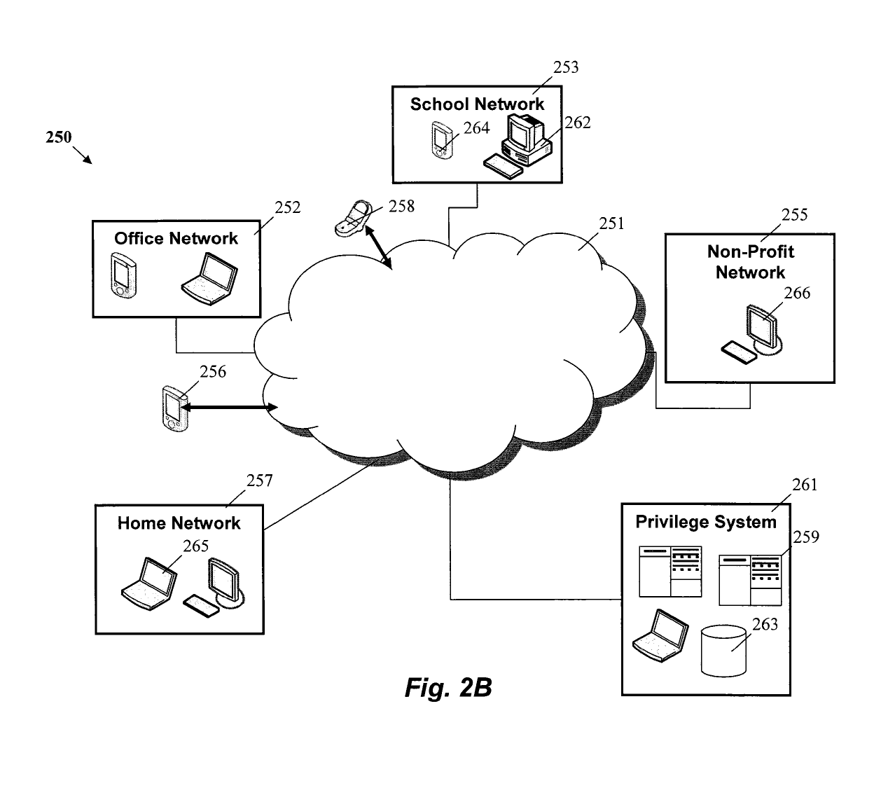

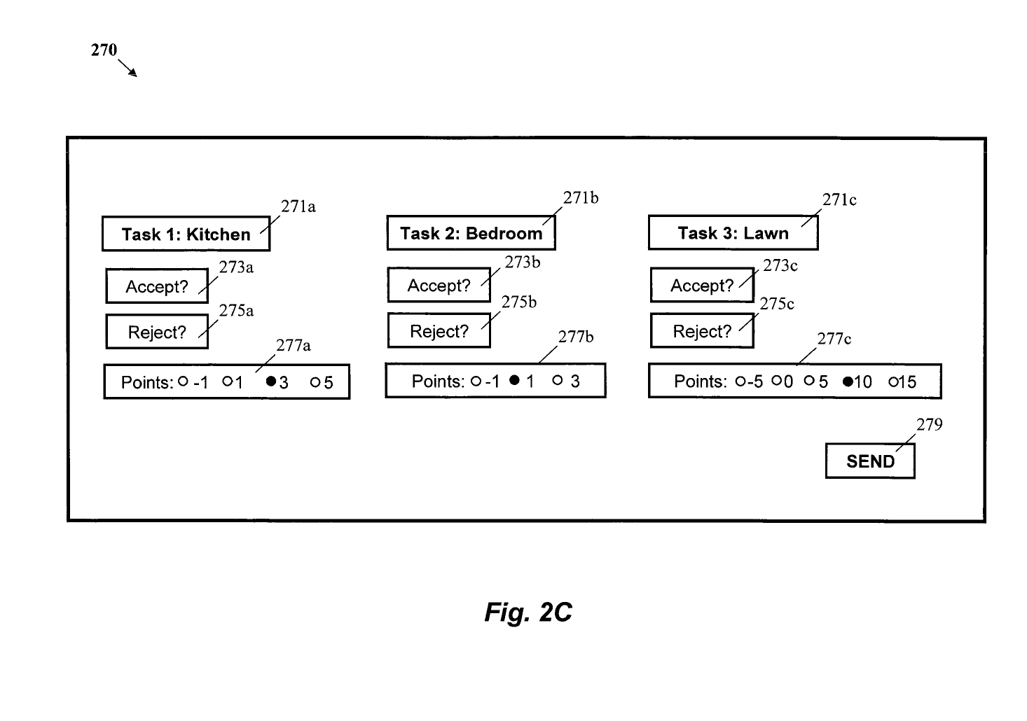

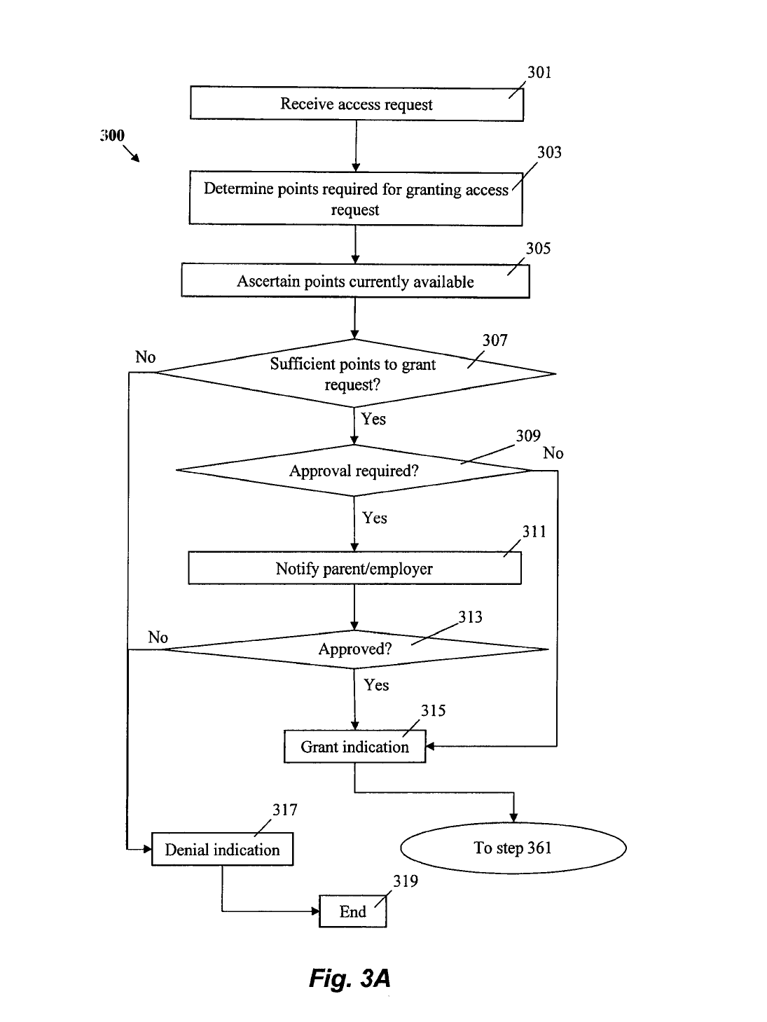

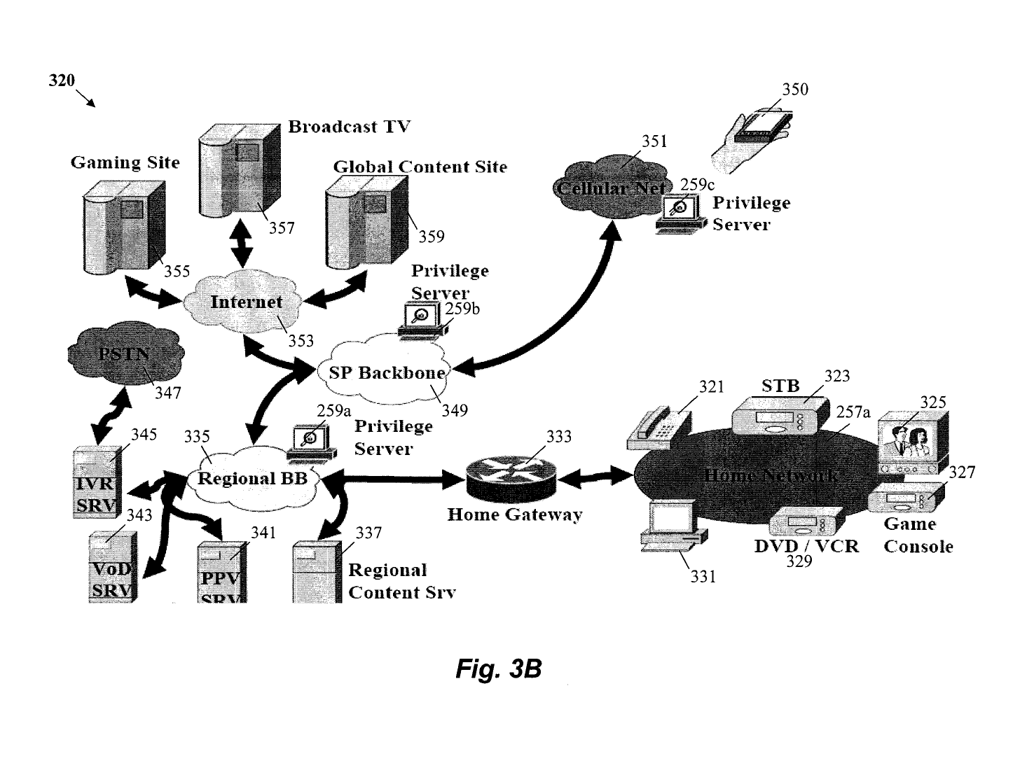

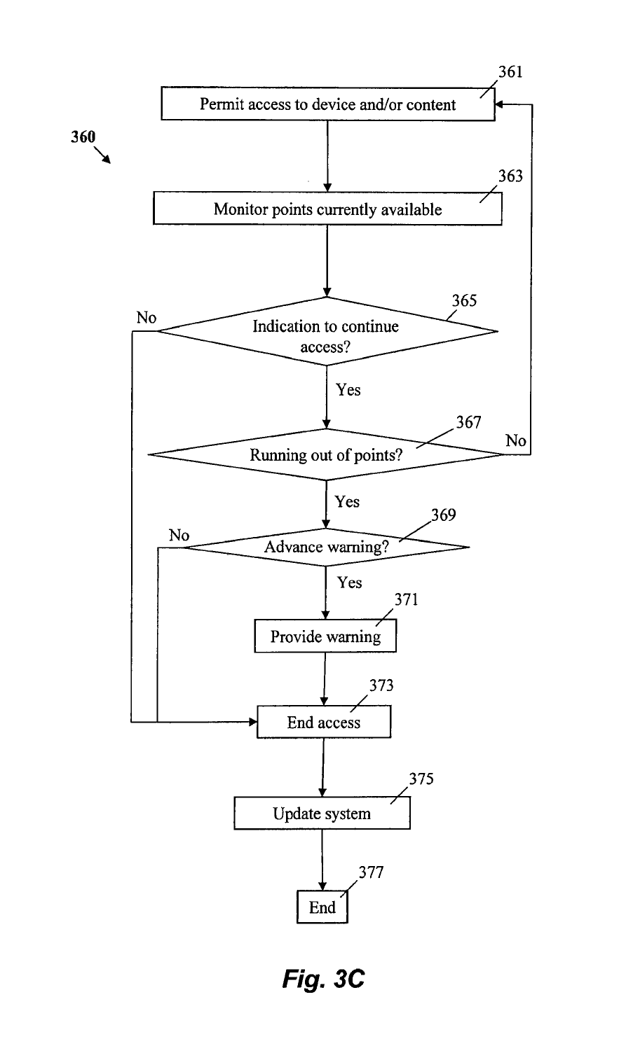

FIG. 1 is a flow chart that outlines a method of enrolling a person in a privilege-based access system. Some steps of method 100 may be performed, for example, by entering data via a user input device of a personal computer, a personal digital assistant, etc., then sending the data to a privilege server, a storage device, etc., via a network. Other steps (e.g., some of the point mappings indicated below) may be performed by a host device, by a server or by another device. Some such devices and networks will be described below, e.g., with reference to FIGS. 2B and 3B. The steps of method 100, like those of other methods of the invention, are not necessarily performed in the order indicated. Moreover, the particular numbers indicated, specific devices that perform the steps, content and/or devices for which access is controlled, etc., that are described herein are only made by way of example and are not intended to be limiting.

In step 101, a process of enrolling a person into a privilege-based access system is initiated by entering registration information. In this example, a child's name and other identification information are entered. A list of desired goals, activities and/or tasks is entered in step 105. (Goals, activities and tasks may be generally referred to herein as “tasks” for the sake of brevity and convenience.) The parent(s) may want their child to accomplish various tasks such as chores, homework, exercise, attend practice sessions for musical groups or athletic teams, perform community service, etc. Accordingly, these tasks are identified in step 105.

Points are assigned to each task. (Step 110.) In this example, the tasks and associated point awards are the result of a discussion between one or more parents and the child/enrollee. The parent(s) and child may, for example, agree to a credit for each activity. In some instances, credits may be positive numbers, negative numbers or zero. Tasks having negative value may be tasks that the parent wishes the child to avoid, such as tardiness or absences at school, athletic practice, band practice, dance rehearsals, etc. However, as noted below, some tasks may have a range of possible values, some of which are positive and some of which are zero or even negative.

In some implementations, the parent may indicate whether tasks will be required or optional. A required task may, for example, need to be completed in order to obtain credit for other tasks. Some tasks may be required even if there is no corresponding point award. For example, the parent may determine that an 18-year-old “child” should be expected to make his/her bed, but may determine that this task will not result in an award of credit. Therefore, the child may be required to complete this task satisfactorily in order to receive credit for, e.g., other tasks performed on a particular day. On the other hand, a parent and child may decide that it would be fair to award an 8-year-old some credit for making his or her bed, or even to make the task optional. Bringing the parent a fresh cup of coffee in the morning may be optional, but could result in a point award.

In some implementations, a task may have a corresponding range of values instead of a single value. For example, a task may have a default value as well as a range of possible values, e.g., a default value of 3 points and a range of 1 to 5 points. In one such example, the parent may know that teachers normally indicate a “check” or the like for the satisfactory completion of a homework assignment, indicate a “check plus” for a superior performance and indicate a “check minus” to indicate a less-than-satisfactory completion of an assignment. The parent may determine, for example, that for assignments having this type of grading pattern, the “check” will be mapped to a 3-point award, a “check minus” to a 1-point award and a “check plus” to a 5-point award.

The parent(s) may establish similar mappings for letter grades, numerical grades, etc. For example, an “A” could correspond to a 10-point award, a “B” could correspond to a O-point award, a “C” could correspond to a minus 10-point award, a “D” could correspond to a minus 20-point award, and so on. Other types and levels of performance may correspond to point ranges. A coach may, for example, award a default number of points for showing up at a game, more points in certain instances (e.g., showing up for a game when it is cold and/or raining, an outstanding performance at the game, etc.) and fewer points in other instances (lack of hustle, talking back, poor attitude, etc.) However, the parent may establish in advance the default number of points, maximum and minimum values, etc.

A parent may be able to select from a range of possible points associated with tasks, e.g., with household tasks. For example, if the child does a great job of cleaning up the kitchen, the child may receive 5 points. If the parent has left the kitchen clean and the child creates and leaves a gigantic mess in the kitchen, the child may receive minus 5 points. Intermediate point values could be assigned according to intermediate circumstances. Some examples are discussed below with reference to FIGS. 2A and 2B.

Such implementations may allow a more flexible assignment of points, e.g., according to the quality of task performance, attitude, cooperation with others, etc. Such implementations may, therefore, include a subjective component, which could have positive or negative ramifications. On the one hand, a child may be motivated by the chance to obtain additional points for higher-level task performance. On the other hand, the child may resent a subjective component if the child believes that the coach, teacher, parent, etc., is biased in some manner. Therefore, assigning a fixed number of points for completing a task may be simpler to implement and may be perceived by the child as less biased and more equitable.

The parent may indicate devices and/or content to be regulated, as well as corresponding credit exchange rates (step 112). Service providers, including but not limited to content providers, may be identified. For example, one or more Internet service provider accounts, content provider accounts (e.g., cable television accounts), etc., may be indicated. One or more telephone numbers, including but not limited to cellular telephone numbers, may be indicated. A home gateway and/or devices in a home network may be identified in some manner, e.g., according to media access control numbers, Internet Protocol addresses, addresses formed according to a local network address translation system, etc. Examples of some such devices, service providers, etc., will be discussed below with reference to FIGS. 3A and 3B.

A parent may determine exchange rates, e.g., in units of credit per unit of time. A parent may indicate, for example, that it will cost the child 5 credits per hour for talking on a cellular telephone, 2 credits per hour for instant messaging, 8 credits per hour for playing a computer game, 20 credits per hour for text messaging, etc. There may be a range of costs according to factors such as the monetary cost of the activity, the parent's perception of the relative merits or harmfulness of the particular activity, etc. Certain types of devices or content may be viewed as relatively benign and may cost less per unit of time. A parent may, for example, insist that games, videos, etc., that involve violence will cost relatively more per unit of time than games that the parent regards as being relatively less harmful.

In this example, a determination will be made in step 115 as to whether the child will receive points a point allowance on a periodic basis or when the privilege-based access control system is initiated. If a parent decides to indicate an initial or periodic point allowance, the conditions (if any), periodicity, numbers of points, point ranges, etc., may be specified. (Step 120.) For example, a parent may require that a child has completed all “required” tasks from the previous time interval (e.g., the previous week) as a prerequisite for obtaining a periodic point allowance. Other parents may require a baseline level of civility from the child in order to obtain a periodic point allowance. Some parents believe that children are entitled to an allowance on a periodic basis, regardless of whether the child has accomplished anything, how the child has behaved, etc., whereas some parents do not share this belief. This example provides the flexibility to implement a range of parenting styles.

Some implementations of the invention, as here, involve a range of trust levels and a corresponding range of verification parameters, e.g., from “verify everything” to “no verify.” In between these extremes there may be various levels of “trust, but verify.” If the parent has a high level of trust in the child, the parent may decide not to verify as much. The trust level and corresponding criteria are established in step 125. Contact procedures may be established in step 130.

In one example, there may be a predetermined range of trust levels, e.g., from 1 to 10. If the parent has a high level of confidence in the child, the parent may select a correspondingly high number, e.g., 8. A high trust level may correspond with a low-level verification procedure. At this trust level, the corresponding verification procedure may be relatively cursory, e.g., the parent may simply receive a notification from the child (e.g., via email) indicating that a task has been completed. In this case, the parent may not need to take any action in order to allow the child to receive a corresponding number of credits, but may be able to challenge the child's assertion if so desired. For example, the parent may realize that the child was supposed to be in school or otherwise without access to email at the time the email notification was sent. In some examples, the parent may be presented with a GUI (e.g., such as that described below with reference to FIG. 2C) that allows the parent to accept or reject the child's asserted task completion. If the parent accepts, the child's account will be credited with the points corresponding to the completed task.

On the other hand, if a parent knows that the child is somewhat unreliable, the parent may insist on a lower trust level, e.g., 3 out of 10. A low trust level may correspond with a relatively high-level verification procedure. At a trust level of 3, the corresponding verification procedure may involve receipt of a notification such as “You need to check the following items.” The parent may, for example, check each one after returning home from work.

A parent may decide to exempt certain categories of tasks from verification. For example, the parent may determine that the child will be able to accrue points that correspond with school-related tasks automatically, without the need for parental approval or verification. In some such examples, the parent may choose to receive a report regarding such items, even if the parent has chosen not to require parental approval for point accrual.

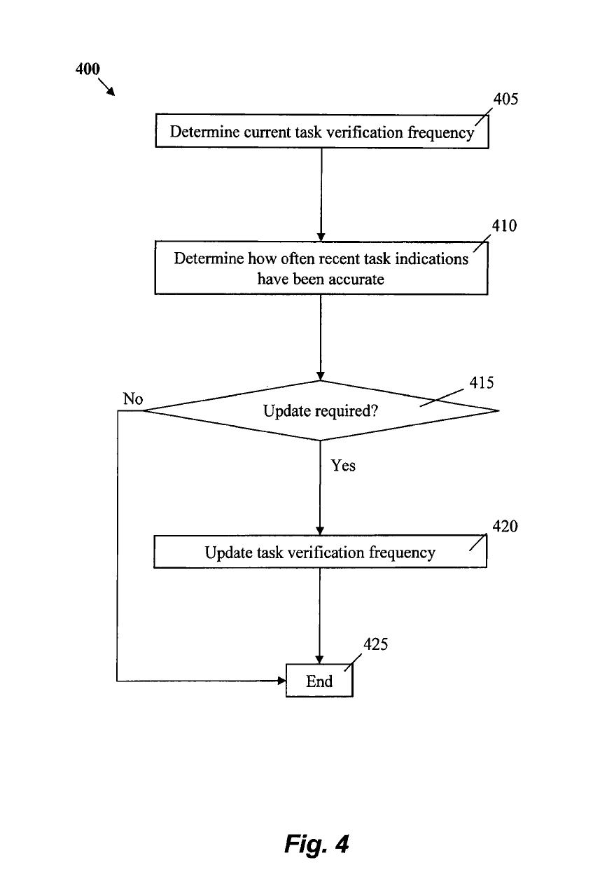

Trust level settings can be a powerful variable for some implementations. A desire to have less parental checking/meddling could inspire children to make sure that they actually do what they say they will do (or, have done what they said they have done). If not, the parent will preferably have the ability to subsequently decrease the “trust level” setting and will check more and more carefully, as needed. Conversely, if the child's actions establish a higher level of trust in the parent, the parent will preferably have the ability to subsequently increase the trust level setting. Applying known metrics to the trust level may make the process seem less arbitrary to the child. An automated process for changing related variables is described below with reference to FIG. 4.

Some implementations, as here, allow the parent to establish “kicker” criteria and corresponding multiplier values for modification of point totals. (Step 140.) In other words, the parent may establish (preferably pursuant to a dialogue with the child) conditions, events or other criteria that can modify a child's point totals, e.g., event-based point totals for a particular time interval, overall point totals, periodic “allowance” points, or whatever category of points the parent indicates.

For example, a parent may indicate that a child's weekly point allowance will be subject to a kicker criterion of “attitude” and a corresponding multiplier in the range of zero to 2. If the child is consistently rude, the parent may choose to apply the “zero” multiplier and the child will not receive a point allowance for that week. On the other hand, if the child is cooperative and helpful, the parent may decide to apply a multiplier value of 2, thereby doubling the child's point allowance for that week.

Some implementations may allow the parent to apply a different multiplier range for different point categories. For example, a parent may have the flexibility to apply a different multiplier range for task-based point accruals, such as those the child earns for doing chores, homework, etc., than for un-earned points that a child receives pursuant to a periodic allowance. In the example of the foregoing “attitude” kicker criterion, the parent may decide to apply a somewhat less draconian multiplier for task-based point accruals (e.g., 0.5) even when that the child has been rude enough to eliminate his or her allowance points for a particular time interval.

Kicker criteria may be based on objectively verifiable data or may be highly subjective. For example, the parent may decide to establish an “attendance” kicker criterion based on indicated attendance metrics and associated multiplier values, e.g., perfect attendance for a predetermined time period (e.g., one month) might correspond to a multiplier of 2.0, whereas specified numbers of absences would correspond to decreasing (and possibly negative) multipliers. School absences and tardiness are well documented and are, in some school districts already reported automatically. Therefore, such a kicker criterion could be based on objectively verifiable data.

FIG. 2A is a flow chart that outlines a process 200 of accruing points in a privilege-based access system. FIG. 2B is a network diagram that illustrates various entities that may be involved in a process of accruing points in a privilege-based access system such as that outlined in FIG. 2A. FIG. 2C is an example of a graphical user interface (“GUI”) that may be provided to assist the parent (or other responsible party) in providing authorization indications in a privilege-based access system such as that outlined in FIG. 2A. As the steps of process 200 are described, some elements of FIGS. 2B and 2C will be referenced to provide context and examples.

After the parent has completed the registration process, paid the required fees, etc., the relevant account in privilege-based access system may be initialized. (Step 201.) In step 203, a privilege server 259 (See FIG. 2B) or another device, such a host device of privilege system 261, determines whether the child should be allocated some initial points. In making this determination, privilege server 259 may refer to registration information stored in one or more storage devices 263 of privilege system 261. If privilege server 259 determines that the child should be allocated some initial points, a number of initial points indicated during the registration process will be allocated. (Step 205 of FIG. 2A.)

Over time, the child will perform various tasks that have been identified in the registration process (step 207). The child, or a third party, will indicate when the tasks have been performed. (Step 209.) Referring again to FIG. 2B, indications may, for example, be sent from one or more devices in school network 253. The indications may be sent in any convenient fashion, e.g., by email via network 251 to privilege system 261. In this example, the cloud of network 251 collectively represents the Internet, a cellular telephone network and any other networks that may be used for communication; some additional examples of networks and devices are described below with reference to FIG. 3B.

In this example, personal computer 262 in a school administrative office has sent indications that the child was late for school, but that the child handed in 3 satisfactory homework assignments. In addition to indications relating to general attendance and academic performance, other types of indications may be received from devices associated with school network 253. For example, indications relating to the child's participation in an athletic team, a musical group, a school newspaper, school politics, etc., may be received. Here, for example, PDA 264 (assigned to a school soccer coach) has indicated that the child participated in a soccer game and scored a goal.

Moreover, indications may be sent from one or more devices associated with other networks, e.g., a network associated with the child's employer or from a network of a community service organization, etc. In this example, iMac 266 of non-profit network 255 has sent an indication that the child failed to show up for volunteer work that day.

The child may also send indications from a device, e.g., a device associated with home network 257, that a task has been completed. The device may or may not be physically located in home network 257 at the time the indication is sent, however. For example, the may send an indication from laptop 265, which is configured for making a wireless connection with the Internet in this example. Alternatively, the child may send one or more indications from a mobile device such as cellular telephone 258, a PDA, etc., while at home or outside the home. In this example, while en route from home to school, the child has sent indications that he made his bed and cleaned up the kitchen before leaving home.

In this example, all indications are first sent to privilege system 261, but this is not necessarily the case. In other implementations, at least some indications may be transmitted directly to a device used by the parent, e.g., to an email account associated the parent and office network 252 or home network 257, to a voice mail system or a text messaging system, etc. Preferably, privilege system 261 is sent a copy of the indication, in order to keep track of the indications, determine whether parental verification is needed, make point determinations, etc.

Privilege server 259 determines whether some level of parental verification is required and, if so, for which tasks and what type of verification. (Step 211 of FIG. 2A.) Again, privilege server 259 may reference registration data that has been input as part of a process such as that of method 100. In this example, privilege server 259 determines that the parent needs to be notified of task completions via email; an email is sent in step 213. In some implementations, the parent may be notified of all task completion indications but will only need to provide an authorization indication for certain categories of tasks, e.g., for home-related tasks, school absences, etc. The parent may be notified periodically or each time that there is a task completion indication. The details regarding notification, verification, etc, may be determined according to the parent's preferences, as indicated by the registration data. Here, the parent receives daily notifications at a predetermined time.

In step 215, privilege server 259 may receive some form of authorization indication from the parent regarding at least some of the task completion indications. The indications may be, e.g., “accepted,” “rejected” or the like. Point values may or may not be included in the authorization indications, according to the implementation. For example, some tasks may correspond to a range of possible point values. In some such examples, the parent may select a point value in the range as part of the task verification process and indicate the point value as part of the authorization indication. Moreover, in some implementations, the parent will only provide an authorization indication for certain categories of tasks, e.g., for home-related tasks.

Some implementations of the invention provide one or more graphical user interfaces (“GUIs”)—or even a specialized device—to assist the parent (or other responsible party) in providing authorization indications. For example, one or more GUIs may be provided for use with a wireless hand-held device, such as personal digital assistant 256 of FIG. 2B.

FIG. 2C depicts an example of one such GUI. GUI 270 currently displays information and tools relating to three tasks. The names of the tasks are indicated in windows 271a, 271b and 271c. Each task has a corresponding “Accept” button (273a, 273b and 273c), a corresponding “Reject” button (275a, 275b and 275c) and a “Points” field (277a, 277b and 277c). In this example, a default point value is indicated in each of the points fields 277a, 277b and 277c. Upon inspecting the kitchen, bedroom and lawn, the parent may make his or her own determinations about the points (if any) that should be awarded for each task. In this example, each of the points fields 277a, 277b and 277c allows the parent to increase or decrease the point award from the default value, or even to assign a negative point value for a really poor job. The parent may use a stylus, touch the screen, or use the appropriate user interface to indicate his or her selections. Activating “SEND” button 279 causes the device displaying the GUI to transmit corresponding authorization indications to privilege server 259.

Privilege server 259 determines how many points should be awarded for each task completion indication. (Step 217 of FIG. 2A.) In this example, the home-based tasks are being evaluated by the parent and the corresponding authorization indications will include the number of points to be awarded. However, other task completion indications (e.g., those from school in this example) may or may not directly indicate points. In some such examples, privilege server 259 will determine how many points should be awarded for these task completion indications by referencing registration data associated with this child's account.

In step 219, privilege server 259 determines whether to apply some form of multiplier value, according to a corresponding kicker. Step 219 may be performed on a periodic basis, on a rolling basis, or in any convenient fashion. In this instance, the parent has indicated an attendance-based kicker during the registration process. The parent has indicated that more than a threshold number of unexcused absences from school or community service during a predetermined time interval will cause a reduction in points. Specifically, the parent has indicated that more than 2 unexcused absences per month or 5 unexcused episodes of tardiness, from school or community service, will result in a 50% reduction in points accrued during a future time interval (here, during the next week). Therefore, in step 219 privilege server 259 evaluates the number of absences and episodes of tardiness for the current month and determines that the child has not yet reached either threshold. Accordingly, privilege server 259 applies no multiplier value for this kicker.

However, privilege server 259 determines that the goal scored in today's soccer game was a qualifying event for another kicker. Therefore, in this example, privilege server 259 applies a corresponding multiplier value of 2 to all points accrued on that day. (Step 221.)

In step 223, privilege server 259 determines whether the process is complete. In this example, step 223 involves determining whether all the pending task indications, potential kickers, etc., have been processed. If so, the process ends. (Step 225.)

FIG. 3A is a flow chart that outlines a process of controlling access to devices and/or content in a privilege-based access system. FIG. 3B is a network diagram that illustrates various entities that may be involved in a process of controlling access to devices and/or content in a privilege-based access system such as that outlined in FIG. 3A.

In step 301, an access request is received. In this example, privilege server 259a receives an access request from set-top box (“STB”) 323 of home network 257a, via home gateway 333. (See FIG. 3B.) In this example, the request is to view a “pay-per-view” (“PPV”) boxing match that could be supplied by PPV server 341, via regional backbone 335. (In this instance, the boxing match could be viewed on television 325.) In other examples, STB 323 may request other types of content, such as that supplied by video on demand server 343 or broadcast television system 357. If the latter, the request would be sent to privilege server 259b in this example.

However, the request could be from any one of various other devices associated with home network 257a, including but not limited to telephone 321, personal computer 331 or game console 327. For example, the child may use game console 327 to send a request to privilege server 259b for access to gaming site 355. The child may use personal computer 331, for example, to send a request to privilege server 259a for access to content from regional content server 337, or a request to privilege server 259b for access to content from global content server 337. The child may use telephone 321 to send a request to privilege server 259a for access to public switched telephone network 347 and/or interactive voice response server 345. Alternatively, the request could be a request for some type of wireless service, e.g., from PDA 350, via cellular network 351, to privilege server 259c.

Privilege server 259a determines the number of points required for granting the access request. (Step 303 of FIG. 3A.) In this example, privilege server 259a evaluates the received access request according to the type of content requested and the length of time for the content to be presented, if known. The boxing match has already taken place, so the total time is known to be approximately one hour. The child's registration information indicates that, in general, 5 points are required to watch television for one hour. However, the content involves violence. According to the registration information, twice as many points are consumed per hour of violent content, as compared with non-violent content (other factors being equal). Therefore, privilege server 259a applies a multiplier of 2 to the normal 5 point/hour requirement and determines that 10 points are required.

In step 305, privilege server 259a determines the number of points that are currently available for the access request. Step 305 may involve a determination of the total number of accrued points to date, whether the child can borrow points if necessary, whether there is a daily (or other) limit on point usage, types of point usage and possibly other factors, according to the implementation. For example, the parent may have set a daily limit on how many points the child can “spend” on violent video games, content, etc. If so, part of the determination of step 305 may be to determine how many points the child has already spent that day on violent video games, content, etc.

In step 307, privilege server 259a determines whether there are sufficient points available to grant the request. If not, privilege server 259a will send a message to the child indicating that the access request is denied. (Step 317.) In this example, however, privilege server 259a determines that at least 10 of the child's points are available for this activity. However privilege server 259a also determines (in step 309) that parental approval is required. Privilege server 259a notifies the parent (step 311), who approves the request (as determined in step 313). Therefore, privilege server 259a grants the access request. (Step 315.)

FIG. 3C is a flow chart that outlines a process of controlling access to devices and/or content in a privilege-based access system after access has initially been authorized, e.g., according to the process outlined in FIG. 3A. In this example, privilege server 259b has previously authorized access to gaming site 355. In step 361, privilege server 259b enables access to gaming site 355.

As the child plays, privilege server 259b (or another device of a privilege system) decrements the child's points as time elapses and monitors the points currently available. In this example, the parent has set a limit of 20 points per day that may be spent on game play, with some types of games (e.g., those involving violence, criminal activity, etc.) consuming points at a higher rate than those that do not. In this example, there are 3 levels of games indicated, with 3 corresponding levels of consumption. If the child switches from one type of game to another, the point consumption level is evaluated and changed, if appropriate.

If the child indicates that he or she wishes to stop play (as determined in step 365), privilege server 259b will terminate the session. (Step 373.) Otherwise, privilege server 259b will continue to monitor the points available to determine whether the child is running out of points. (Step 367.) In some implementations, privilege server 259b will determine whether to provide an advance warning when the child is nearly out of points. (Step 369.) If so, one will be provided in step 369. Privilege server 259b may, for example, send a message to the child's device indicating the time remaining. After the session is complete, one or more data structures may be updated to indicate the child's current number of total points, points consumed for the day, the activities that were involved in point consumption, how much time the child spent on these activities, etc. (Step 375.)

FIG. 4 illustrates a process of evaluating and modifying a task verification frequency according to some implementations of the invention. For example, the privilege-based access system may indicate that at the current trust level, the parent needs to verify the child's task completion indications at a particular time interval, e.g., once every 3 days, every 5 days, every day, once a week, etc. The task verification frequency, which may be referred to herein as an “audit rate” or the like, could change according to the child's behavior, e.g., with longer time intervals corresponding to better behavior. Moreover, some classes of tasks (e.g., cleaning the child's bedroom) may have different audit rates than other classes of tasks (e.g., cleaning the kitchen).

An audit rate may be closely related to a trust level. In some such implementations, the audit rate may be determined by a corresponding trust level, such that if one is changed the other also is changed. In other implementations, the audit rate and the trust level may be more loosely coupled; for example, there may be a range of possible audit rates associated with a given trust level.

According to method 400, the process begins by determining a current audit rate. (Step 405.) In this example, privilege server 259 determines that the current audit rate for the child's bedroom is once per week. In step 410, privilege server 259 determines the percentage of time that the child's task completion indications have been accurate during a predetermine time interval (e.g., during the last month). In this example, privilege server 259 determines whether an audit rate update is indicated (step 415) according to how often the child's task completion indications have been accurate.

Here, if child's task completion indications have been accurate 80% to 90% of the time during the past month, the audit rate remains the same. If child's task completion indications have been accurate less than 80% of the time, privilege server 259 may determine that the audit rate should be increased. For example, if the accuracy rate is between 50% and 80%, privilege server 259 may determine that the audit rate should be increased to a predetermined level (e.g., twice per week), whereas if the accuracy rate drops below 50%, privilege server 259 may determine that the audit rate should be increased to a predetermined higher level (e.g., every day).

Here, however, the child's task completion indications have been accurate more than 90% of the time during the past month. Therefore, privilege server 259 determines that the audit rate should be decreased. (Step 420.) In this example, privilege server 259 determines that the audit rate should be decreased to once every 2 weeks. Preferably, the parameters for modifying the audit rate are clarified (and may, in some implementations, be specified) during the registration process, so that the child realizes that the audit rate is determined by his or her own actions.

### Other Embodiments

The methods of the present invention may be implemented, at least in part, by hardware and/or software. For example, some embodiments of the invention provide computer programs embodied in machine-readable media. The computer programs include instructions for controlling one or more devices to perform the methods described herein.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the present embodiments are to be considered as illustrative and not restrictive, and the invention is not to be limited to the details given herein, but may be modified within the scope and equivalents of the appended claims.

I claim:

1. A method, comprising:
receiving personal identification data for a first person;
receiving device identification data for at least one identified device;
receiving task identification data indicating at least one identified task;
receiving point data indicating task points corresponding to each identified task and indicating device usage points required to use each identified device for a unit of time; and
controlling access of the first person to at least one identified device according to the point data.

2. The method of claim 1, further comprising receiving content identification data for at least one type of identified content, wherein receiving point data comprises receiving an indication of points required to access identified content for a unit of time, and wherein controlling access of the first person comprises controlling access to at least one type of identified content.

3. The method of claim 1, further comprising:
receiving a task indication that the first person has completed an identified task; and
ascertaining a number of points to award.

4. The method of claim 1, further comprising receiving trust level data corresponding to a verification requirements for task indications.

5. The method of claim 1, wherein the task points corresponding to at least one identified task comprise a range of points that may be awarded.

6. The method of claim 1, wherein the point data further comprise kicker criteria and corresponding multiplier values for modification of event-based point totals.

7. The method of claim 2, wherein the controlling step comprises:
receiving an access request from the first person to access an identified device or identified content;
ascertaining a number of points required for granting the access request; and
ascertaining a number of points currently available to the first person.

8. The method of claim 3, further comprising receiving contact information for a second person, wherein the ascertaining step comprises:
notifying the second person according to the contact information;
receiving an authorization indication from the second person; and
determining a number of points to award according to the authorization indication.

9. The method of claim 4, wherein the trust level data comprise audit rate data indicating a task verification frequency.

10. The method of claim 5, wherein the ascertaining step comprises:
determining a task performance level; and
determining a number of points to award according to the task performance level.

11. The method of claim 9, wherein the audit rate data are based, at least in part, on a frequency at which task indications from the first person are accurate.

12. An apparatus, comprising:
a network interface system comprising at least one network interface; and
a logic system comprising at least one logic device and configured to do the following:
receive, via the network interface system, task indications that a first person has completed predetermined tasks;
ascertain points to award for the predetermined tasks;
receive, via the network interface system, an access request to access identified content;
determine a number of points required for granting the access request;
determine a number of points currently available to the first person;
determine whether to grant the access request; and
send, via the network interface system, a message to a device indicating whether to grant the access request.

13. The apparatus of claim 12, wherein the access request comprises a request to access an identified device.

14. The apparatus of claim 12, wherein the logic system is further configured to determine whether a second person needs to authorize the grant.

15. The apparatus of claim 12, wherein the ascertaining comprises:
notifying a second person;
receiving an authorization indication from the second person; and
determining a number of points to award based, at least in part, on the authorization indication.

16. The apparatus of claim 12, wherein the logic system is further configured to determine a task verification frequency based, at least in part, on how often the task indications from the first person are accurate.

17. The apparatus of claim 14, wherein the logic system is further configured to perform the following tasks when the logic system determines that a second person needs to authorize the grant:
notify the second person of the access request;
receive an authorization indication from the second person; and
determining whether grant the access request based, at least in part, on the authorization indication.

18. An apparatus, comprising:
means for receiving task indications that a first person has completed predetermined tasks;
means for ascertaining points to award for each task indication;
means for receiving access requests for the first person to access identified content;
means for determining a required number of points for granting each access request;
means for determining whether to grant each access request, based at least in part on comparing the required number of points to a number of points available to the first person when each access request is received; and
means for sending a message to a device indicating whether to grant the access request.

19. The apparatus of claim 18, wherein at least some access requests comprise requests to access an identified device.

20. The apparatus of claim 18, wherein the ascertaining means comprises:
means for notifying a second person;
means for receiving an authorization indication from the second person; and
means for determining a number of points to award based, at least in part, on the authorization indication.
